(19) United States
(12) Patent Application Publication
(10) Pub. No.: US 2009/0277013 A1
(43) Pub. Date: Nov. 12, 2009

(54) Utensil

(76) Inventors: Jan Hendrik Tesner, George (ZA); Jacoba Katharina Tesner, George (ZA)

Correspondence Address: LADAS & PARRY LLP, 224 SOUTH MICHIGAN AVENUE, SUITE 1600, CHICAGO, IL, 60604, US

(21) Appl. No.: 11/911,143

(22) PCT Filed: Aug. 14, 2007
(86) PCT No.: PCT/IB2007/053218

§ 371 Date: Apr. 27, 2009

(30) Foreign Application Priority Data
Aug. 14, 2006 (ZA) 2006/06722

(51) Int. Cl. A47J 43/00

(52) U.S. Cl. 30/120.1

(57) ABSTRACT

A utensil for liberating the contents of an egg from the shell of the egg. The utensil includes an egg support for holding the egg and a shell cracker formation for cracking the shell of the egg held by the egg support, the shell cracker formation being moveable between a rest position and a crack position. The utensil further includes an actuator for connection to the shell cracker formation, the actuator being moveable between a first position and a second position wherein movement of the actuator from its first position to its second position will cause the shell cracker formation to move from its rest position to its crack position.

### BACKGROUND TO THE INVENTION

THIS invention relates to a utensil. In particular the invention concerns a utensil which can be used for cracking the shell of an egg to liberate the yolk and the white of the egg from its shell.

Persons who often prepare foodstuffs incorporating chicken eggs will attest to the difficulty often incurred in cracking an egg without causing at least some bits of egg shell from finding its way into the item of food being prepared. As any person who has ever had the misfortune of biting down on a piece of egg shell will know, such an occurrence could cause some measure of discomfort.

Furthermore, any person who has ever attempted to break an egg will agree that some amount of skill is required if none of the contents of the egg is to be spilled onto one's hands.

It is an object of the invention to address the above problems.

### SUMMARY OF THE INVENTION

According to the present invention there is provided a utensil for liberating the contents of an egg from the shell of the egg:
an egg support for holding the egg;
a shell cracker formation for cracking the shell of the egg held by the egg support, the shell cracker formation being moveable between a rest position and a crack position; and
an actuator for connection to the shell cracker formation, the actuator being moveable between a first position and a second position wherein movement of the actuator from its first position to its second position will cause the shell cracker formation to move from its rest position to its crack position.

Preferably the utensil includes biasing means for causing the shell cracker formation to return from its crack position to its rest position and as a consequence causing the actuator to move form its second position to its first position.

More preferably the egg support defines a holding cavity in which the egg can be held.

Advantageously the egg support comprises a first and a second support member which is movable between a support position and a release position.

In an embodiment of the invention the biasing means acts on the shell cracker formation via the egg support.

Typically the egg support can be connected to the actuator such that movement of the actuator from its first position to its second position will cause the first and second support members to move from their support position to their release position.

Advantageously the first and second support members each include a pivot formation.

Preferably the egg support includes a guide formation for guiding movement of the shell cracker formation from its rest position to its crack position.

More preferably the shell cracker formation comprises a first and a second cracker member.

Typically the first and second cracker members each comprise a support arm, a shell breaker and an actuator connector.

Advantageously the actuator comprises a first and a second actuator member.

Preferably the first and the second actuator members each comprise a handle, cracker member connector and a pivot arrangement.

More preferably the utensil includes a cover assembly.

Typically the cover assembly comprises a first and a second cover.

Advantageously the second cover includes a pivot element for connection with the pivot formation of the first and second support members and the pivot arrangement of the first and second actuator members.

Preferably the utensil includes a separator which can be used for separating the white and the yolk of an egg.

### BRIEF DESCRIPTION OF THE DRAWINGS

The invention will now be described in more detail, by way of example only, with reference to the accompanying drawings wherein:

FIG. 1 shows a front view of a utensil in accordance with the invention wherein an actuator of the utensil is located in a first position;

FIG. 2 shows a front view of the utensil wherein the actuator is located in a second position;

FIG. 3 shows a side view of the utensil;

FIG. 4 shows a perspective view of a first support member of an egg support of the utensil;

FIG. 5 shows a perspective view of a second support member of the egg support;

FIG. 6 shows a perspective view of a first crack member of a shell cracker formation of the utensil;

FIG. 7 shows a perspective view of a second crack member of the shell cracker formation of the utensil

FIG. 8 shows a perspective view of a first actuator member of the actuator of the utensil;

FIG. 9 shows a perspective view of a second actuator member of the actuator;

FIG. 10 shows an enlarged front view of biasing means of the utensil;

FIG. 11 shows an enlarged side view of the biasing means;

FIG. 12 shows a perspective view of a first cover of a cover assembly of the utensil;

FIG. 13 shows a perspective view of a second cover of the cover assembly; and

FIG. 14 shows a perspective view of a separator of the utensil.

### DESCRIPTION OF THE ILLUSTRATED EMBODIMENT

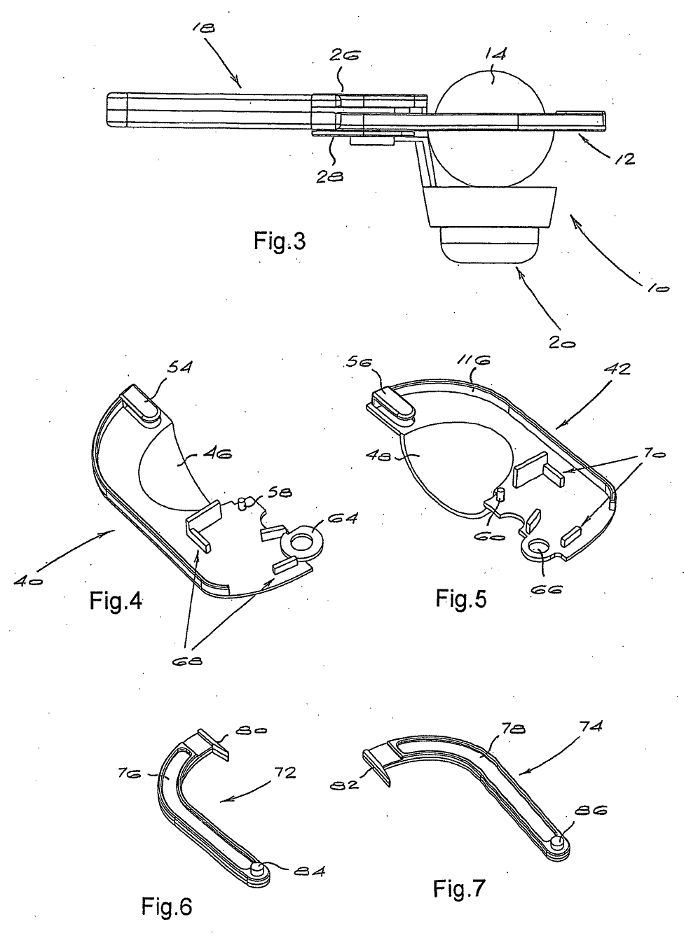

FIGS. 1 to 3 show a utensil in accordance with the present invention, generally indicated with the reference numeral 10. For ease of explanation the operation of the utensil 10 will first be described in broad principles with reference to the mentioned drawings whereafter the individual components constituting the utensil 10 will be described in detail.

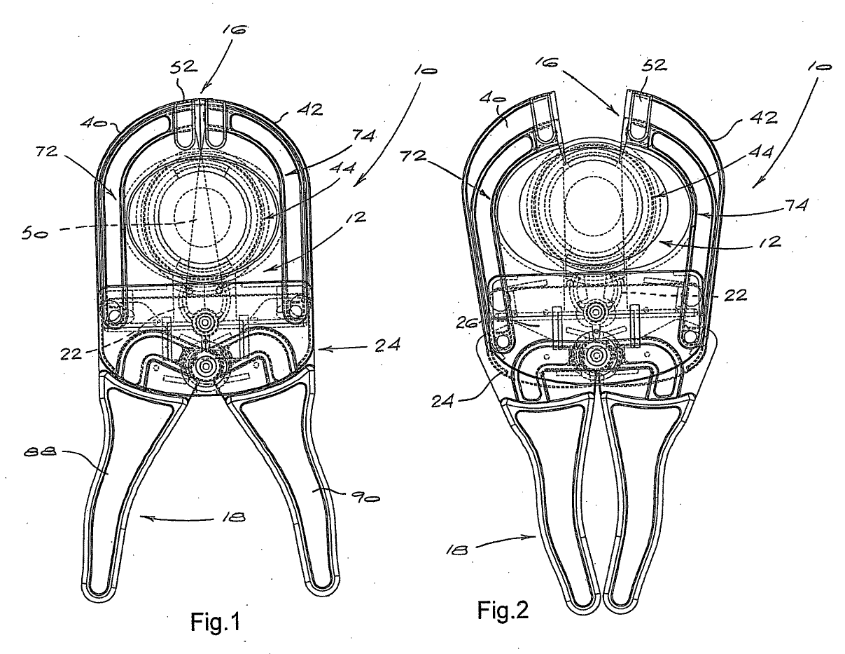

As mentioned previously the utensil 10 of the invention finds specific application in liberating the contents of an egg, typically a chicken egg, from the shell of the egg. The utensil 10 firstly comprises an egg support 12 for holding an egg 14 and secondly a shell cracker formation 16 for cracking the shell of the egg 14. The shell cracker formation 16 is movable between a rest position, shown in FIG. 1, and a crack position, shown in FIG. 2. The utensil 10 also comprises an actuator 18 for connection to the shell cracker formation 16. The actuator 18 is movable between a first position, shown in FIG. 1, and second position, shown in FIG. 2. The connection between the actuator 18 and the shell cracker formation 16 is such that when the actuator 18 is moved from its first position to its second position the shell cracker formation 16 will be caused to move from its rest position to its crack position. The utensil 10 also includes a separator 20, the function of which will be explained below.

A person desirous to make use of the utensil 10 for removing the egg white and yolk of the egg 14 from its shell will typically hold the actuator 18 in one hand. By applying a compressive force on the actuator 18, the actuator will be caused to move from its first position to its second position, consequently causing the shell cracker formation 16 to move from its rest position to its crack position. As the shell cracker formation 16 is caused to move from its rest position to its crack position it will firstly abut the outside of the shell of the egg 14. Continued movement of the actuator 18 will cause the shell cracker formation 16 to penetrate the shell of the egg 14 to form a crack. Continued movement of the actuator 18 will result in further movement of the shell cracker formation 16. The brittle nature of the shell of a chicken egg will have the effect that the crack will propagate across the shell such that by the time that the shell cracker formation 16 has reached its rest position, the crack will span the circumference of the egg 14.

The contents of the egg will now fall under the influence of gravity from the egg support 12, as will be explained below, into the separator 20. The separator 20 is configured such that it will hold the yolk of the egg while the egg white will be allowed to pass through the separator 20 to be discarded.

The user can now release the actuator 18 and due to the fact that the utensil incorporates biasing means 22, here in the form of a resilient element shaped as shown in FIGS. 10 and 11, the shell cracker formation 16 will return from its crack position to its rest position simultaneously causing the actuator to return from its second position to its first position.

After removing the now empty shell of the egg from the egg support 12, a fresh egg can be placed on the egg support so that the above described process can be repeated.

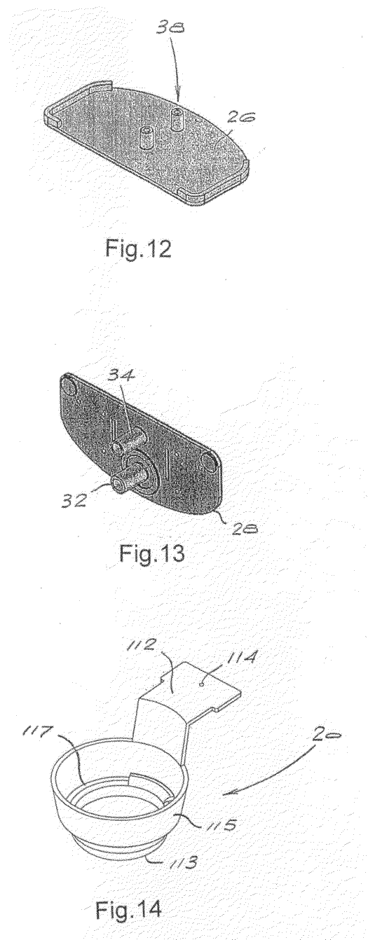

To ensure that the egg support 12, shell cracker formation 16, actuator 18 and biasing means 22 are secured in position, the utensil 10 is provided with a cover assembly 24. The cover assembly 24 comprises a first cover 26 and a second cover 28 which are shaped as shown respectively in FIGS. 12 and 13.

The second cover 28 is provided in the form of a plate which carries a pivot element 32 and biasing means holder 34. The biasing means holder 34 is provided in the form of a cylinder which can hold a corresponding sleeve 36, see FIGS. 10 and 11, of the biasing means 22 thereby to secure the biasing means in position. The first cover 26 is also provided in the form of a plate and carries holding formations 38 for cooperating with the pivot element 32 and biasing means holder 34 on the second cover 28, thereby to secure the first and the second cover 26 and 28 to the utensil 10.

The egg support 12 comprises a first and a second support member 40 and 42 which define a holding cavity 44 in which the egg 14 can be placed. As shown in FIG. 4 and FIG. 5 the support members 40 and 42 each have a curved portion, indicated respectively with the reference numerals 46 and 48, which in the assembled condition of the egg support 12 will define the holding cavity 44. The curved portions 46 and 48 are further shaped such that they form a gap 50, see FIG. 1, through which the contents of the egg 14 can fall from the egg support 12 once the egg has been cracked.

The egg support 12 also includes a guiding formation 52 for guiding movement of the shell cracker formation 16 between its rest position and its crack position. The guiding formation 52 is formed by providing that the first and second support members 40 and 42 each carry a guide member, indicated respectively with the reference numerals 54 and 56, which is shaped as shown.

The first and second support members 40 and 42 further includes biasing means anchors 58 and 60 respectively which can be held by arms 62 of the biasing means 22. To facilitate pivotable connection to the pivot element 32, the support members 40 and 42 are each provided with a pivot element connector 64 and 66. Finally, the support members 40 and 42 are each provided with movement guides 68 and 70 for guiding movement of the actuator 18 and the shell cracker formation 16 relative to the egg support 12 when the actuator is caused to move between its first position and second position and the egg cracker formation 16 between its rest position and crack position.

The shell cracker formation 16 of this embodiment of the invention is provided in the form of a first and a second cracker member, shown in FIGS. 6 and 7 and indicated respectively with the reference numerals 72 and 74. Each cracker member comprises a support arm 76 and 78 as well as a shell breaker 80 and 82 for forming a crack in the shell of an egg. Each cracker member 72 and 74 further also includes an actuator connector 84 and 86 whereby they can be connected to the actuator 18.

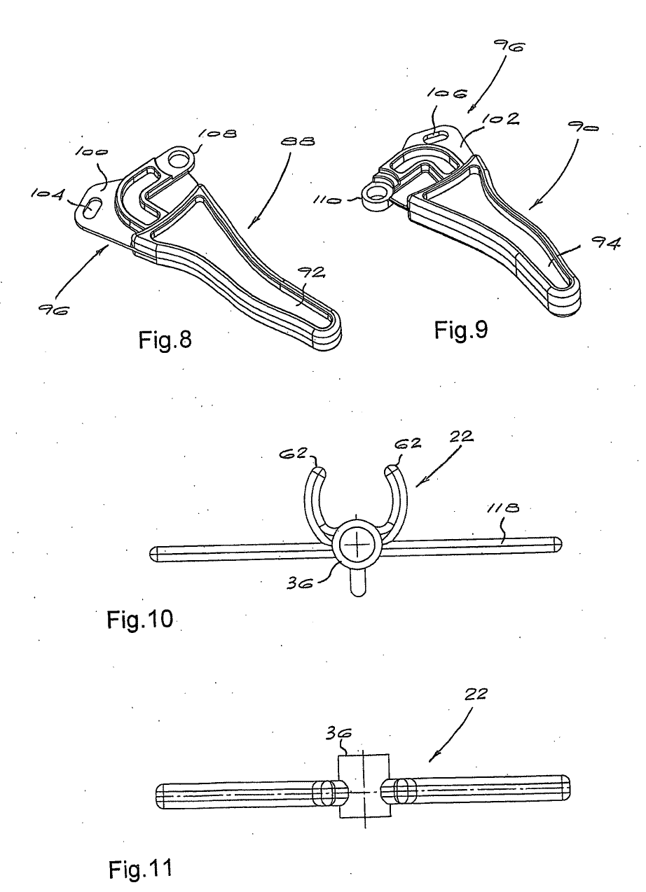

The actuator 18 comprises first and second actuator members 88 and 90, see FIGS. 8 and 9, which in turn each include respectively a handle 92 and 94 as well as a cracker member connector 96 and 98. In this embodiment of the invention each cracker member connector 96 and 98 comprises a plate 100 and 102, respectively having slots 104 and 106 which are suitably sized for respectively holding the actuator connectors 84 and 86 of the cracker members 72 and 74. Finally the actuator members 88 and 90 each have a pivot arrangement 108 and 110 allowing it to be connected pivotally to the pivot element 32.

FIG. 14 shows the separator 20 of the invention. The separator 20 comprises a connecting member 112 which is shaped as shown. The separator 20 can be attached to the second cover 28 with suitable fastening means such as an adhesive or by using, for example, a faster to pass through a cavity 114 in the connecting member 112 and locate in a corresponding cavity in the second cover 28, not shown.

The separator 20 also comprises a yolk holder 113 and a rim 115 which defines a slot 117. In use the yolk of the egg will fall into the yolk holder 113 and the egg white will be separated from the yolk by falling under the influence of gravity through the slot 117.

The mechanics of the utensil 10 will now be described with reference to the operation of its components located on the right-hand side as shown in FIG. 1 of the drawings. These components are namely the actuator member 90, the cracker member 74 and the second support member 42. The operation of the components on the left-hand side will simply mirror the operation as described below so that no specific description of these components is believed to be necessary for a complete understanding of the working of the utensil 10.

Upon a user exerting a compressive force on the handle 94 of the actuator member 90, the actuator member will move from its first position towards its second position. As the actuator member 90 moves it will cause the pivot arrangement 110 to pivot about the pivot element 32 consequently inducing the plate 102 to impart movement on the actuator connector 86 of the cracker member 74. The configuration of the plate 102 is such that it will cause the cracker member 74 to move from its rest position towards its crack position to induce a crack in the egg being held by the egg support 12. As the cracker member 74 undergoes movement it will in turn induce movement in the second support member 42 via a wall 116, see FIG. 5, consequently causing the second support member to move from its support position towards its release position. Movement of the second support member 42 will induce an arm 118 of the biasing means 22 to be pulled from its rest position to a biased position.

Once the actuator member 90 has reached its second position the egg will have been cracked and the contents of the egg will have fallen under the influence of gravity through the gap 50 in the egg support 12 into the separator 20.

The user can now release his grip on the handle 94. Upon release of the compressive force exerted on the handle 94 by the user the biasing means 22 will start to return to its unbiased position consequently causing the second support member 42 to move from its release position towards its support position. This in turn will allow the cracker member 74 to return from its crack position to its rest position and, in turn, allow the actuator member 90 to return to its first position from where the above procedure can be repeated when a second egg is to be cracked.

A utensil in accordance with the above description will induce a crack in the shell of an egg without creating loose bits of egg shell. Furthermore, as a person breaking the egg will not physically touch the egg, none of the contents of the egg can be spilled onto the hands of the user.

1. A utensil for liberating the contents of an egg from the shell of the egg:
an egg support for holding the egg;
a shell cracker formation for cracking the shell of the egg held by the egg support, the shell cracker formation being moveable between a rest position and a crack position; and
an actuator for connection to the shell cracker formation, the actuator being moveable between a first position and a second position wherein movement of the actuator from its first position to its second position will cause the shell cracker formation to move from its rest position to its crack position.

2. A utensil according to claim 1 including biasing means for causing the shell cracker formation to return from its crack position to its rest position and as a consequence causing the actuator to move form its second position to its first position.

3. A utensil according to claim 1 wherein the egg support defines a holding cavity in which the egg can be held.

4. A utensil according to claim 1 wherein the egg support comprises a first and a second support member which is movable between a support position and a release position.

5. A utensil according to claim 2 wherein the biasing means acts on the shell cracker formation via the egg support.

6. A utensil according to claim 4 wherein the egg support can be connected to the actuator such that movement of the actuator from its first position to its second position will cause the first and second support members to move from their support position to their release position.

7. A utensil according to claim 6 wherein the first and second support members each include a pivot formation.

8. A utensil according to claim 7 wherein the egg support includes a guide formation for guiding movement of the shell cracker formation from its rest position to its crack position.

9. A utensil according claim 8 wherein the shell cracker formation comprises a first and a second cracker member.

10. A utensil according to claim 9 wherein the first and second cracker members each comprise a support arm, a shell breaker and an actuator connector.

11. A utensil according to claim 10 wherein the actuator comprises a first and a second actuator member.

12. A utensil according to claim 11 wherein the first and the second actuator members each comprise a handle, cracker member connector and a pivot arrangement.

13. A utensil according to claim 12 including a cover assembly.

14. A utensil according to claim 13 wherein the cover assembly comprises a first and a second cover.

15. A utensil according to claim 14 wherein the second cover includes a pivot element for connection with the pivot formation of the first and second support members and the pivot arrangement of the first and second actuator members.

16. A utensil according to claim 1 including a separator which can be used for separating the white and the yolk of an egg.

17. (canceled)
